(19) United States
(12) Patent Application Publication
(10) Pub. No.: US 2010/0057630 A1
(43) Pub. Date: Mar. 4, 2010

(54) System And Method For Providing Automated Real Estate Transaction Management With Centralized Transaction Information Storage

(76) Inventor: Tracy E. Dale-Thiebout, Snohomish, WA (US)

Correspondence Address: CASCADIA INTELLECTUAL PROPERTY, 500 UNION STREET, SUITE 1005, SEATTLE, WA, 98101, US

(21) Appl. No.: 12/618,635

(22) Filed: Nov. 13, 2009

Related U.S. Application Data
(63) Continuation of application No. 11/134,869, filed on May 20, 2005.
(60) Provisional application No. 60/573,084, filed on May 21, 2004.

(51) Int. Cl. G06Q 50/00; G06Q 10/00; G06F 3/048

(52) U.S. Cl. 705/316; 715/760

(57) ABSTRACT

A system and method for providing automated real estate transaction management with centralized transaction information storage is described. Transaction information is centrally maintained and includes a plurality of transaction specifications. Each such transaction specification includes one or more deadlines that provide an agent component and a client component. An agent view is presented by interactively parsing through the transaction specification for at least one client of an agent and determining sections of the transaction information relating to the agent component. A client view is displayed by generating a hierarchy of the deadlines applicable to the real estate transaction and interactively providing select parts of the transaction information relating to the client component. Completion of the real estate transaction is dependent upon the completion of the agent component and the client component.

### CROSS-REFERENCE TO RELATED APPLICATION

This patent application is a continuation of U.S. patent application Ser. No. 11/134,869, filed May 20, 2005, pending, which is a non-provisional patent application of U.S. provisional patent application Ser. No. 60/573,084, filed May 21, 2004, the disclosures of which are incorporated by reference.

### FIELD

The invention relates in general to real estate transaction management and, in particular, to a system and method for providing automated real estate transaction management with centralized transaction information storage.

### BACKGROUND

Real estate transaction management requires balancing the competing demands of clients, including purchasers and sellers, and third parties, such as vendors and other agents, against an ever-changing marketplace. Many basic information needs can be met by existing tools. For instance, automated databases of real estate listings are widely available over the Worldwide Web (“Web”), which provide property descriptions, locations, prices, and other information of use to potential real estate purchasers and sellers. Transacting the sale or purchase of real estate, however, generally requires the assistance of a licensed real estate agent who is responsible for sheparding transaction process, from search or listing through property titling and closure. In addition, real estate agents often provide helpful marketing and educational programs to prospective clients.

Success can be a qualified reward and managing a full load of real estate clients can be time-intensive and challenging. Each client has different needs and tastes, which are matched to the actual property listings available in a particular geographic market. Once a suitable property is found, in-progress transactions are subject to numerous deadlines, generally specified by state law applicable to a particular jurisdiction. Transaction deadlines are critical milestones and each agent, client or third party might be responsible for timely completing the steps necessary to satisfy each deadline. Ensuring that the milestones are timely met can be tricky, particularly where a client or third party has the responsibility to complete a particular task and which requires follow up by the agent to ensure that the task was performed.

Often, efficient real estate transaction management can be strongly affected by the experience of the agent. Still, transaction deadlines can be missed by novice and experienced agents alike and remembering to guide a client can sometimes be a matter of careful tact. The default timing for deadlines is typically set by state law but could be modified, in some cases, by contract or by the early or late completion of a preceding deadline. As the facilitator of a transaction, the real estate agent is ultimately charged with tracking deadlines, varying deadlines when appropriate, and keeping the responsible parties informed.

Additionally, real estate transactions often involve third parties to the actual transaction. These third parties include banking institutions, trust and title companies, other agents, vendors, and various professional and journey personnel contributing towards the completion of one or more deadline components for a transaction. As a result, maintaining third party contacts is critical, particularly when related to an on-going real estate transaction.

Similarly, on-going client relationships are dynamic and require continuous updating. Purchasers want to know about new or changed listings, while sellers want to be market savvy. For instance, in a real estate purchase setting, an initial set of real estate listings will change as old listings are sold and new listings are added. Moreover, client preferences can change as necessities and preferences evolve in light of real estate listings viewed and other factors. Real estate agents are responsible for ensuring such client needs are satisfied, even though client satisfaction can sometimes be a moving target.

Currently, general automated productivity tools provide only partial solutions to fulfilling the particularized needs of real estate agents. Contact management programs track people and scheduler programs track deadlines. Web-based search engines, such as multiple listing services, facilitate searching real estate listing databases. Nevertheless, such ad hoc transaction management solutions lack interoperability and are not able to easily accommodate schedule or deadline changes particular to a given real estate transaction. As well, scheduler programs are generally configured to be personal to an agent. Consequently, clients are unable to determine agent availability without first manually contacting the agent to arrange an appointment.

Therefore, there is a need for an approach to providing an integrated real estate transaction manager with agent-specific and client-specific viewing interfaces. Preferably, such an approach would support contact, schedule and deadline tracking on a per-transaction basis. Moreover, customizable features, including client attributes and profiles, would be dynamically definable over individual clients or by real estate transaction.

### SUMMARY

An embodiment provides a system and method for providing automated real estate transaction management with centralized transaction information storage. Transaction information is centrally maintained and includes a plurality of transaction specifications. Each such transaction specification includes one or more deadlines that provide an agent component and a client component. An agent view is presented by interactively parsing through the transaction specification for at least one client of an agent and determining sections of the transaction information relating to the agent component. A client view is displayed by generating a hierarchy of the deadlines applicable to the real estate transaction and interactively providing select parts of the transaction information relating to the client component. Completion of the real estate transaction is dependent upon the completion of the agent component and the client component.

Still other embodiments of the invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the invention. Accordingly, the drawings and detailed description are to be regarded as illustrative in nature and not as restrictive.

### BRIEF DESCRIPTION OF THE DRAWINGS

FIG. 1 is a functional block diagram showing a real estate transaction environment.

FIG. 2 is a process flow diagram showing a real estate purchase.

FIG. 3 is a process flow diagram showing a real estate sale.

FIG. 4 is a block diagram showing a system for providing automated real estate transaction management with centralized transaction information storage, in accordance with the invention.

FIG. 5 is a screen shot showing, by way of example, a Web page for providing automated real estate transaction management, for use with the system of FIG. 4.

FIG. 6 is a flow diagram showing a method for generating an agent view, in accordance with the invention.

FIG. 7 is a flow diagram showing a method for generating a client view, in accordance with the invention.

### DETAILED DESCRIPTION

### Real Estate Transaction Environment

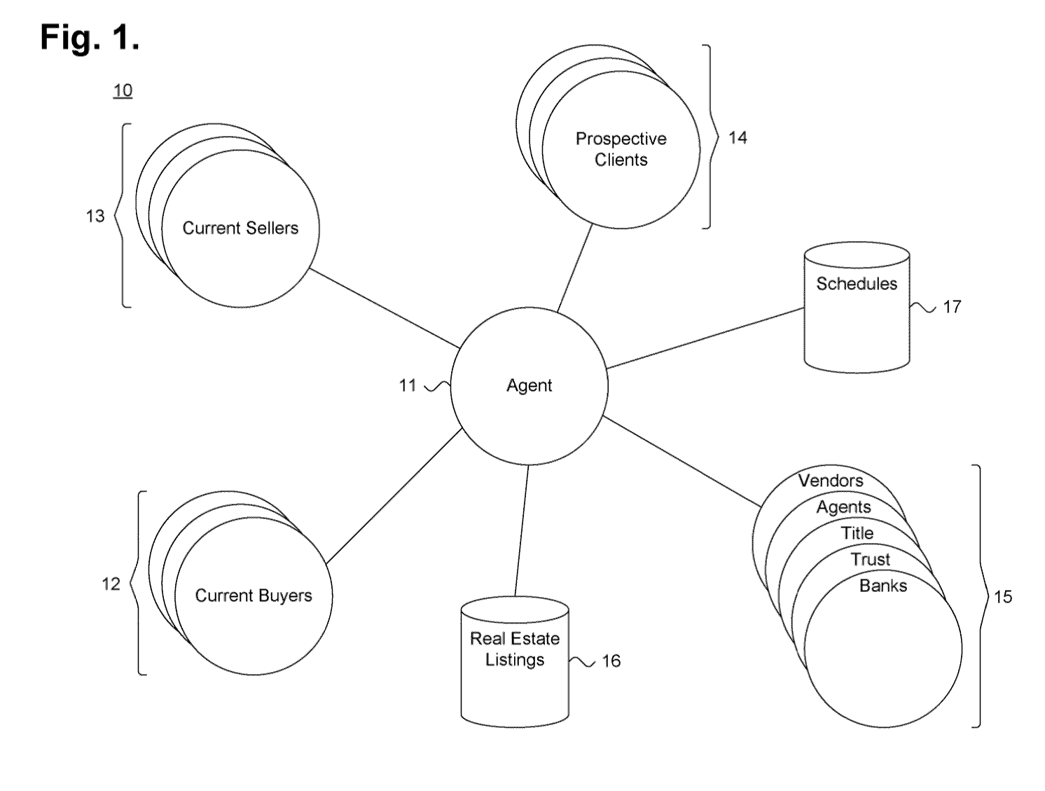

FIG. 1 is a functional block diagram showing a real estate transaction environment 10. Typically, a real estate agent 11 is involved in nearly all aspects of a real estate transaction, before, during and after each transaction. An agent 11 interacts with four broadly-defined groups of individuals or parties, which include current buyers 12, current sellers 13, prospective clients 14, and third parties 15. Other individuals or parties are possible.

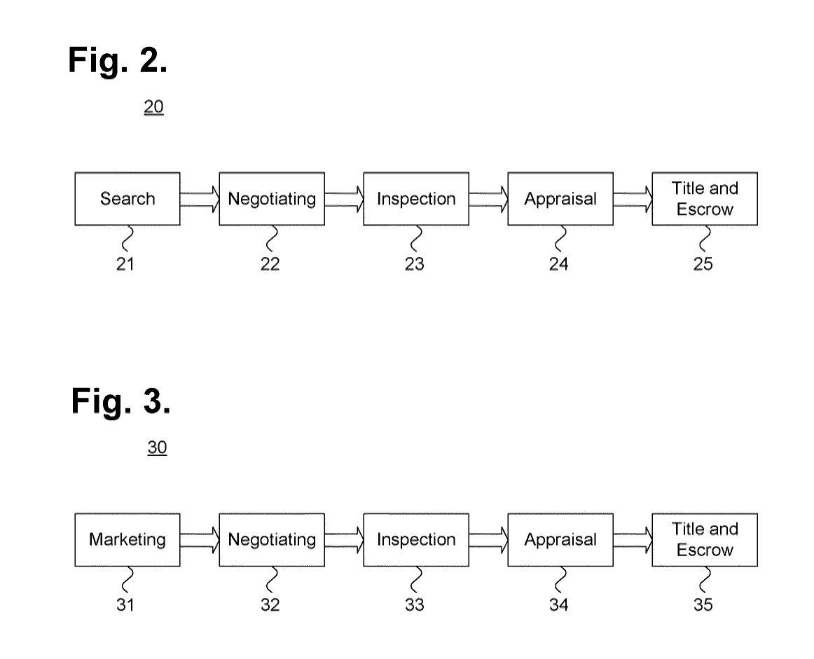

Current buyers 12, current sellers 13 and prospective clients 14 represent the group of clients for an agent 11. Current buyers 12 and current sellers 13 represent a group of active parties that are involved in an on-going real estate transaction or in a potential real estate transaction. Current buyers 12 include parties that are interested in purchasing one or more properties, as further described below with reference to FIG. 2. Current sellers 13 include parties that are interested in selling one or more properties, as further described below with reference to FIG. 3. The agent 11 accesses a database of real estate listings 16, such as a multiple listing service, to provide potential listings of interest to the current buyers 12 and generate marketing information for the current sellers 13. Prospective clients 14 include both former buyers and sellers, as well as other parties that may potentially develop into a current buyer 12 or a current seller 13. Prospective clients 14 arc developed by an agent 11 through marketing and educational opportunities, such as newsletters and home sale and purchasing seminars. Other types of clients are possible.

Third parties 15 include those parties serving a function complementary or collateral to those performed by the real estate agent 11. Examples of third parties 15 include banks, trust companies, title companies, other real estate agents, vendors, and various professional and journey personnel. In a further embodiment, the Web pages can include advertisements, such as in the form of pull down or popup menus, which advertise the goods and services offered by the third parties 15 in exchange for advertising revenue.

During the processing of a real estate transaction, the activities of the agent 11, client, whether current buyer 12 or current seller 13, and often, third parties 15 are driven by a set of schedules 17. The schedules 17 are derived from deadlines created in response to statutory and regulatory requirements governing the sale and purchase of real estate in accordance with the state law applicable to a particular jurisdiction. The schedules 17 can be dynamic and often change in response to actions completed by the agent 11, clients, third parties 15 or as varied by contract. Other factors in addition to or in lieu of the schedule 17 can also affect a real estate transaction.

### Real Estate Purchase Process

FIG. 2 is a process flow diagram showing a real estate purchase 20. A typical real estate purchase 20 proceeds though five phases. During the search phase (operation 21), the current buyers 12 view real estate listings and properties with their agent 11 based on their needs and preferences. Upon finding a suitable property, the agent 11 and current buyers 12 negotiate with the sellers of the property (operation 22). If a deal is reached, the negotiations conclude with mutual acceptance and the formation of a sales contract. Thereafter, the property can undergo an inspection (operation 23) and appraisal (operation 24) to ascertain the condition and fair market value of the property. Both the inspection and appraisal can result in a return to negotiating (operation 22) if significant problems or disparities arise. The appraisal is generally completed at the request of a bank or lending institution for their own benefit where the property is offered as the collateral on a purchase loan. Finally, closing is performed by completing title transfer and escrow (operation 25). Title transfer involves the physical execution of a title document by the buyers and sellers, preferably following title inspection. Escrow involves a third party that transfers the money and documents from the buying and selling parties. Additional phases or steps could be required and the overall process is generally regulated by state law.

### Real Estate Sale Process

FIG. 3 is a process flow diagram showing a real estate sale 30. The real estate sale process is a mirror image of the real estate purchase process, as further described above with reference to FIG. 2. During the marketing phase (operation 31), the current sellers 13 undertake a marketing analysis with their agent 11 to determine an appropriate selling price and schedule for the property. Marketing includes, for example, identifying comparable properties, taking photographs, listing the property, setting an advertising campaign, scheduling showing information, advertising, and providing open houses. Upon receiving an offer, the agent 11 and current sellers 13 negotiate with the potential buyers of the property (operation 32). If a deal is reached, the negotiations conclude with mutual acceptance information of a sales contract. Thereafter, the property can undergo an inspection (operation 33) and appraisal (operation 34) to ascertain the condition and fair market value of the property. Finally, closing is performed by completing title transfer and escrow (operation 35). Additional phases or steps could be required and the overall process is generally regulated by state law.

### Automated Real Estate Transaction Management System

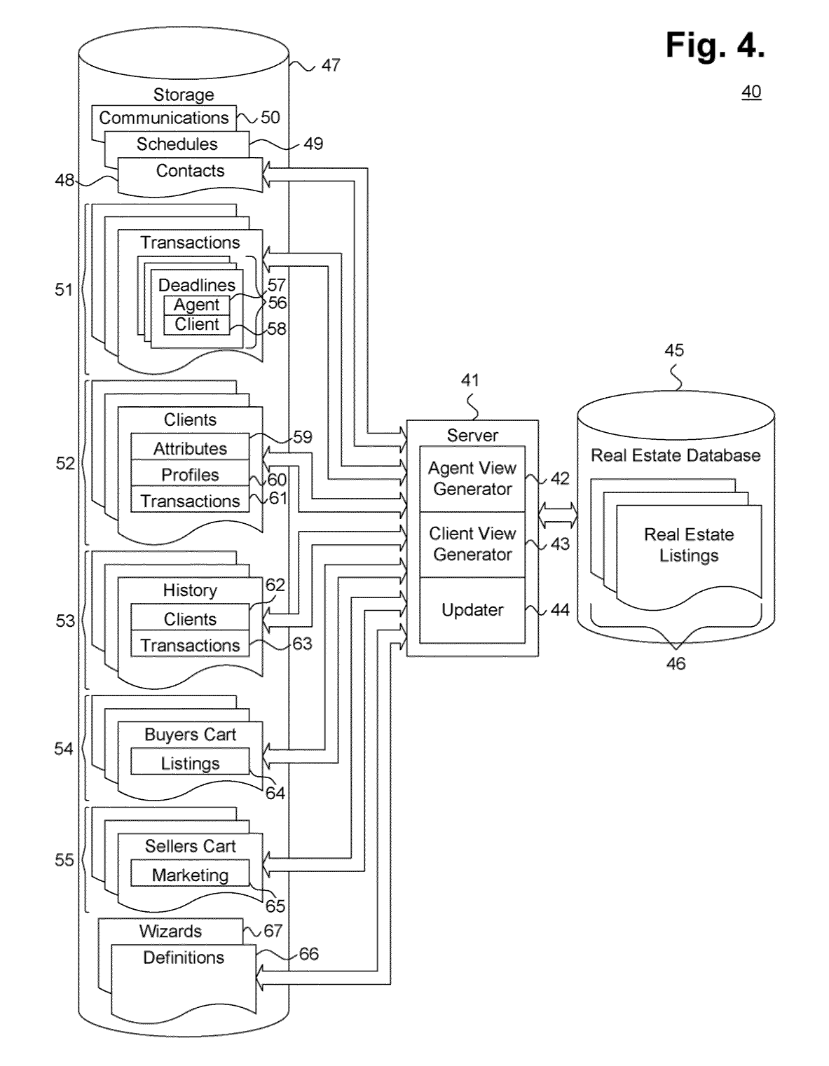

FIG. 4 is a block diagram showing a system 40 for providing automated real estate transaction management with centralized transaction information storage, in accordance with the invention. The system 40 includes a server 41, real estate database 45 and centralized storage 47. The server 41 manages real estate transactions for both agents 11 and clients, including current buyers 12 and current sellers 13, using transaction information maintained in the centralized storage 47. However, the transaction information is presented in a different manner for an agent versus a client. Thus, the server 41 includes an agent view generator 42, client view generator 43 and updater 44.

In the described embodiment, the server 41 is implemented as a Web server that generates the agent view and client view as a set of hyperlinked pages written in a tag-delimited page description language, such as the Hypertext Markup Language (HTML) or Extensible Markup Language (XML), preferably supplemented by active content, such as Java scripts or active server page (ASP) scripts. Other types of Web pages and agent and client views are possible.

Each agent view presents one or more activities through automated assistants, known as wizards 67. Each client view presents a hierarchy of an on-going real estate transaction, supplemented by definitions 66 of terms and other related information helpful to the client. The agent and clients views will now be discussed in further detail.

Agent View

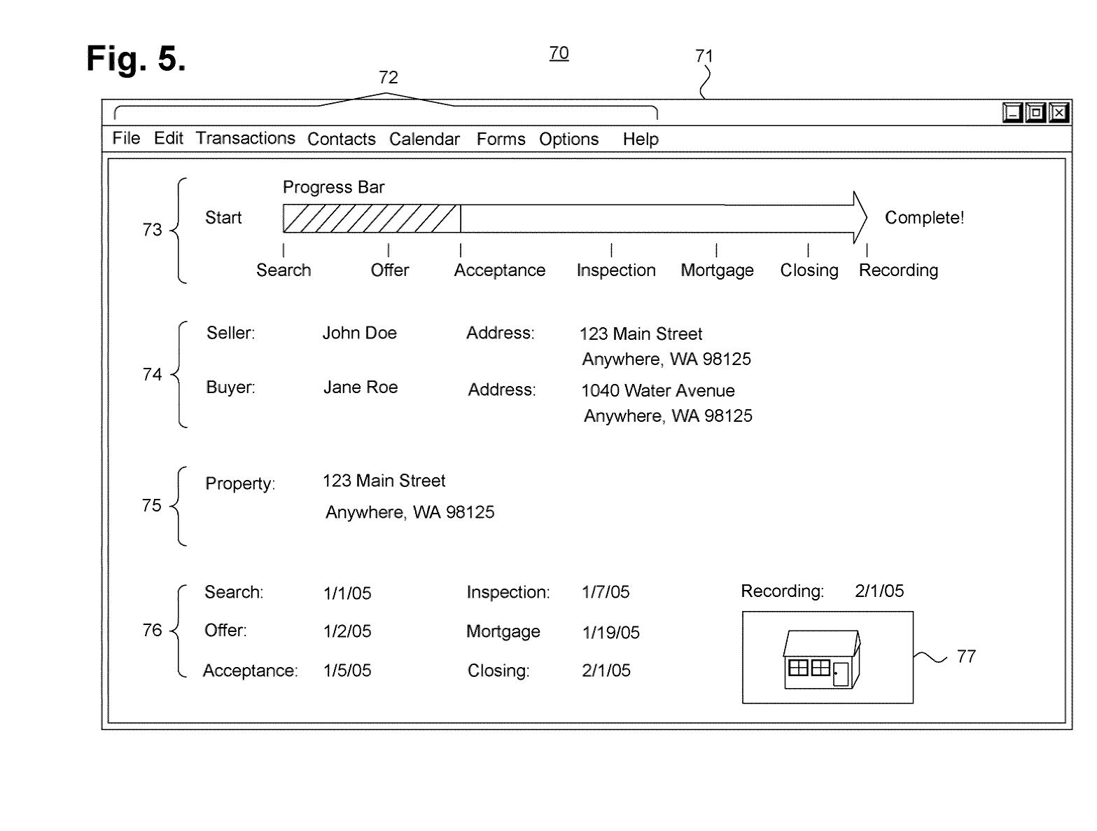

Agents can update the status of an on-going or planned transaction by updating their status on the appropriate Web page, such as through a menu or data entry box, as further described below, with reference to FIG. 5. The agent view includes a contacts manager, scheduler and communications interface for respectively maintaining a set of contacts 48, schedules 49 and undertaking communications 50 with clients and third parties. The contacts 48 reference a set of clients 52, which are each maintained with a set of attributes 59, profiles 60 and, if applicable, one or more real estate transactions 61. The attributes 59 correspond to a status associated with the client. For instance, a client could be identified with an attribute as a current buyer 12, current seller 13 or prospective client 14. The attributes 59 can be used by the agent 11 for executing queries and bulk operations, such as generating newsletters or targeted mail. Preferably, each client 52 and contact 48 are identified uniquely by an e-mail address, although any other form of unique identifier could be used. The profiles 60 are based on a phase of a real estate transaction in which the client is currently involved. For instance, a buyer profile assists the agent 11 in identifying those properties that best suit the needs of a client. A buyer profile can include parameters such as number of bedrooms, number of bathrooms, square footage, lot size, top feature requirements, and top feature preferences, as well as others. Similarly, a seller profile is geared towards assisting an agent in successfully marketing and selling a property on behalf of a client. The seller profile can include selling price, comparable properties, photographs, links to listings, market updates, current advertising campaign, showing information, agent activities, advertising, and open houses, as well as others. Finally, each client 52, if applicable, includes references 61 to one or more transactions 51.

Each transaction 51 includes multiple deadlines 57, which each have an agent component 57 and client component 58. In the described embodiment, each transaction 51 is not complete until both the agent and client components 57, 58 of each deadline 56 are completed. The deadlines 57 are system-calculated with default deadlines determined in accordance with applicable state law, or as agent-specified. System-calculated deadlines can be based on business or calendar days and are recalculated when a dependency date is completed early or late. Business deadlines are adjusted for state holiday schedules and contract stipulations on threshold business days.

Client View

Clients can also update the status of an on-going or planned transaction by updating their status on the appropriate Web page, such as through a menu or data entry box, as further described below with reference to FIG. 5. The client view includes one or more real estate listings 47 relating to either the purchase or sale of a property. The real estate listings 46 are retrieved from a real estate database 45, such as a multiple listings service. In a further embodiment, the updater 44 periodically or upon demand queries the real estate database 45 to identify those real estate listings 46 that have either changed or been added since the last set of real estate listings 46 were provided to the client. In addition, the updater can be triggered by updates to the client information or changes in a client status as performed by the agent 11, such as creating a new system logon, changing a dateline and so forth.

The schedules 49 include the deadlines 56 assigned to both the agent 11 and the client and can be accompanied by an indication of whether an action is currently pending, in progress or has been completed. In the described embodiment, the deadlines are colored coded with green signifying an eventual deadline, yellow signifying a near deadline, red signifying a due deadline, and white signifying a completed deadline. Other types of coding and prioritizations are possible.

Ideally, the agent 11 and clients communicate on a regular basis to exchange information and status by selecting status changes on the Web site, such as through a menu or data entry box. The communications can include, for example, voicemail, facsimile, e-mail, paging, text messaging and instant messaging. In a further embodiment, a history 53 of both clients 62 and transactions 63 is maintained. Other types of communications and history data are possible.

The client views are tailored to the particular profile 60 assigned to a client. Where the client is a current buyer 12, a buyers cart 54 is stored, which includes a set of real estate listings 64 identified to that particular client. In addition, the client can view the listings 64 and schedule a viewing or appointment with the agent 11. In the described embodiment, access to the calendar of the agent 11 is limited to only viewing available time slots and not the actual content describing details of other appointments appearing on the calendar of the agent 11. For a client identified as a current seller 13, a sellers cart 55 includes marketing information 65 relating to the property being sold by the agent 11. The marketing information can also be supplemented by select real estate listings 46.

Web Page

Agent and client views can be provided through a Web-based interface displayed on, for instance, a browser application executing on a personal computer system, including desktop and notebook computers, personal digital assistants, and other Web-enabled devices, interfaced through wireless or wired means. FIG. 5 is a screenshot 70 showing, by way of example, a Web page 71 for providing automated real estate transaction processing, for use with the system 40 of FIG. 4. The Web page 71 provides a generic presentation of selections, menus, and information that can be used by agents or clients to manage real estate transactions. In a further embodiment, the Web page 71 can be customized for the particularized needs of agents 11, current buyers 12, current sellers 13, prospective clients 14, and third parties 15, and can be provided either as a single Web page or as a series of hierarchically-related or linked Web pages, including separate Web sites. Other organizations and arrangements of particularized Web pages are possible.

The Web page 71 includes a series of pull down menus 72, including File, Edit, Transactions, Contacts, Calendar, Forms, Options, and Help. Other pull down menus are possible. The File, Edit, and Help pull down menus respectively provide data storage and retrieval, data editing, and user assistance, as commonly provided through standardized Web-based user interfaces. The Transactions pull down menu enables a user to select from a set of real estate transactions, including current and historical transactions. Agents 11 in particular can use the Transactions pull down menu to manage their transactions in an efficient and user-friendly fashion. The Contacts pull down menu, also of particular interest to agents 11, allows access to information organized to facilitate communications with other parties, including names, addresses, affiliation, telephone numbers, e-mail addresses, instant messaging, and similar parameters in an integrated and fully-linked presentation. The Calendar pull down menu provides an at-a-glance view organized, for instance, by week, month, or year, of deadlines and other dates of noteworthy concern with respect to one or more real estate transactions. The Forms pull down menu allows a user to obtain access to authorized forms that can be imported into a transaction, including automatically pre-populating information and organizing the proper set of forms necessary for one or more stages of a transaction. The forms can be provided, for instance, by a multiple listing association for use by a contract creator, that is, a licensed agent, and can also be modified from original format, if necessary. Purchase and listing forms could also be available for buyer and seller downloading, faxing, printing, e-mailing, or viewing, as appropriate. The Options pull down menu item provides access to customization features and ancillary features that allow data importing and exporting to other applications, such as Microsoft Outlook or Lotus Notes. Other types of options are possible.

A progress bar 73 is displayed on the Web page 71 to track various aspects of a transaction from, for instance, search through recording. Other types of progress bars for various types of transactions or real estate processes are possible. A set of milestones are included in the progress bar, such as Search, Offer, Acceptance, Inspection, Mortgage, Closing, and Recording, and each milestone can be linked to a further Web page or popup window to provide additional information or options. The progress bar 73 includes an indication of current status to allow easy determination of where a transaction currently stands. Specific progress bars could be generated for various aspects of transactions or real estate processes, such as listing processes, multiple listing views, marketing views, flyers, brochures, Web sites, educational programs, ordering titles, and mortgage and lending aspects.

Finally, the Web page 71 can also include additional information, such as parties to a transaction 74, property information 75, specific dates 76, and an image of the property 77. Other types of information are possible.

In one embodiment, duplication of data is minimized or eliminated by prompting a user to fill out initial Web-based forms, which are used to store data records into a database for later use. In addition, the stored data, for instance, user preferences, could be used for marketing purposes, with the appropriate authorizations, such as marketing demand and demographic research, directed marketing campaigns, and related uses. The fields in the various Web pages and forms are subsequently populated automatically with the stored data to eliminate the need for a user, such as an agent 11, to manage each task individually, once a task has been assigned to a client in an appropriate category.

In a further embodiment, the Web page 71 can include an embedded interface to access, for example, title, escrow, and mortgage programs, for interacting with the system 40, which provides appropriate privacy protections when allowing different parties to view certain aspects of a transaction or contract. Additionally, forms can be generated for communicating through e-mail to various parties for automatically uploading solicited data to the server 41 for appropriate parties to view. In particular, the Web page 71 for current sellers 13 can contain required forms that can be sent by e-mail or fax to their agent 11, as well as feedback and automatic market update and pertinent news downloads from their agents 11.

In a still further embodiment, the Web page 71 can be supplemented to address specific circumstances, such as, accommodating a home builder with construction deadlines, as well as customized versions for various multiple listings associations and builder sites.

In a still further embodiment, a customized version of the Web page 71 can provide agents 11 with a view that is automatically opened into calendar. Each agent 11 would be able to select alternatives to a calendar default view. Timelines can be downloaded directly to a personal digital assistant or similar device and could further be exportable as a standalone program for legacy users, such as agents 11 who lack Web access. Finally, plug-in or linked-in features can be used to supplement the Web page 71 with, for example, an automated created contract for a current buyer 12 or current seller 13 or a new listing entered into the server 41 could trigger an e-mail or facsimile to order a title or open escrow. Similarly, a link can be provided in a third party Multiple Listing Service could allow agents to access listing or buyer specific information. As well, a link can be provided to a calendar to schedule appointments that would interface with the buyer and the seller sides and also provide feedback links. Other types of plug-in, linked-in, or innovative features are possible, such as automatically e-mailing, telephoning, or faxing scheduled reminders as transaction timelines approach or change. The reminders could be provided in an icon in a system tray or through various views on a Web page 71.

In still further embodiment, a history field (not shown) for agents 11 allows previous transactions to be stored for possible future reference. Similarly, brokers can be provided access by an agent or by override to ensure that novice agents are following proper procedures. Other agent-particular features are possible.

The particularized Web page 71 for current sellers 13 includes the ability to send out follow-up forms to agents 11 showing a listing for seller feedback that is automatically populated for the stored data. Similarly, the Web page 71 can include the ability to create appointments for listing viewings that can be sent via e-mail or through off-site call centers and the like.

The particularized Web page 71 for current buyers 12 includes the ability to map a tour for a buyer, as well as include other helpful information, such as schools and areas of interest. The Web page 71 also includes the ability to create appointments for listing viewings that can be sent via e-mail or through off-site call centers and the like.

### Agent View Generation Method

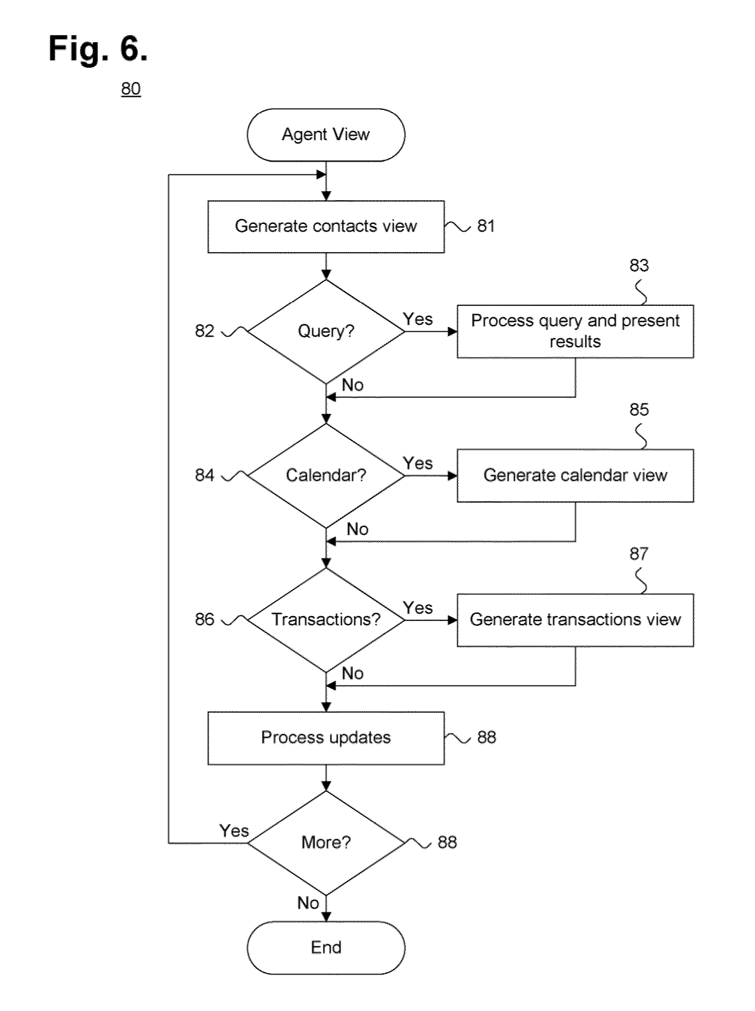

FIG. 6 is a flow diagram showing a method for generating an agent view 80, in accordance with the invention. The purpose of this routine is to generate a default agent view and process activities selected by the agent 11.

Initially, a contacts view is generated (block 8), which displays to the agent 11 contacts, which include clients and third party contents. Optionally, the agent 11 can execute a query (block 82) against the transaction information stored in the centralized storage 47, which is processed and presented (block 83). Similarly, the agent 11 can access a calendar (block 84), which is generated as a calendar view for visualizing the schedules 49 (block 85). Finally, the agent 11 can perform actions on one or more transactions currently in progress (block 86), which is generated and propagates further changes to the agent component 57 of the deadlines 56 (block 87). Finally, any updates to the transaction information maintained in the centralized storage 47 can be processed (block 88) and, if further operations are required (block 89), processing continues. Otherwise, the method terminates.

### Client View Generation Method

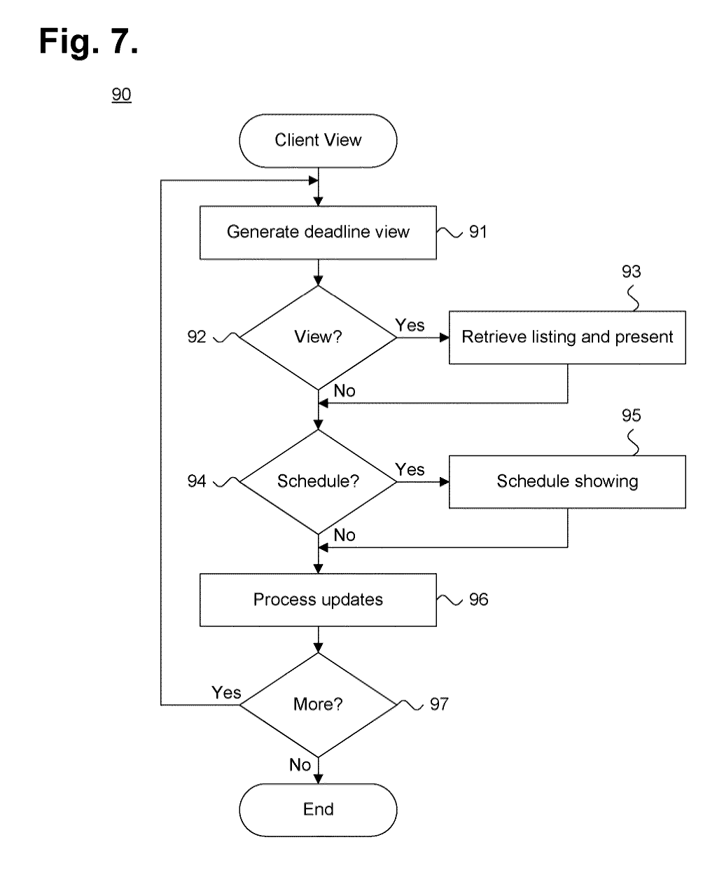

FIG. 7 is a flow diagram showing a method for generating a client view 90, in accordance with the invention. The purpose of this routine is to generate a default client view and process activities selected by the client.

Initially, those deadlines 56 appearing in a client component 58 are displayed (block 91). Optionally, the client can view one or more real estate listings 46 (block 92), which are retrieved and presented (block 93). Similarly, the client can schedule time for a viewing or an appointment with the agent 11 (block 94), which is shown and propagated to the schedules 49 (block 95). Any updates to the transaction information maintained in the centralized storage 47 can be processed (block 96) and, if further operations are required (block 97), processing continues. Otherwise, the method terminates.

While the invention has been particularly shown and described as referenced to the embodiments thereof, those skilled in the art will understand that the foregoing and other changes in form and detail may be made therein without departing from the spirit and scope of the invention.

What is claimed is:

1. A system for providing automated real estate transaction management with centralized transaction information storage, comprising:
a data base configured to centrally maintain transaction information comprising a plurality of transaction specifications with each such transaction specification comprising a plurality of deadlines associated with at least one of an agent and a client that respectively provide an agent deadline component and a client deadline component, wherein completion of each transaction specification is dependent upon completion of the agent deadline component and the client deadline component;
an agent Web page configured to present an agent view for an agent, comprising:
a retrieval module configured to retrieve the transaction specification from the transaction information for at least one client specified by the agent;
a filter module configured to determine sections of the transaction specification relating to the agent deadline component; and
an agent interface configured to interactively provide the transaction specification sections to the agent and to update the completion of the agent deadline component; and
a client Web page configured to present a client view for a client, comprising:
a hierarchy module configured to generate a stored hierarchy of the deadlines applicable to the transaction specification retrieved; and
a selector module configured to interactively provide select parts of the transaction specification to the at least one client relating to the client deadline component and to update the completion of the client deadline component.
